(19) United States
(12) Patent Application Publication
(10) Pub. No.: US 2009/0225042 A1
(43) Pub. Date: Sep. 10, 2009

(54) SYSTEMS AND METHODS FOR ENHANCEMENT OF MOBILE DEVICES

(75) Inventors: Barry D. ANDREWS, Los Altos, CA (US); Daniel F. ZUCKER, Palo Alto, CA (US)

Correspondence Address: LEVINE BAGADE HAN LLP, 2400 GENG ROAD, SUITE 120, PALO ALTO, CA, 94303, US

(73) Assignee: Wake3, LLC, Los Altos, CA (US)

(21) Appl. No.: 12/043,050

(22) Filed: Mar. 5, 2008

(51) Int. Cl. G06F 3/041

(52) U.S. Cl. 345/173

(57) ABSTRACT

Systems and methods for enabling the use of multi-touch applications on touch screens configured to receive only a single touch input at a time are disclosed. Systems and methods for dual heap memory allocation are also disclosed. Systems and methods for meta-layer rendering for mark-up code on mobile devices and storage of the meta-layers is also disclosed. Combinations of the above systems and methods are further disclosed.

### BACKGROUND OF THE INVENTION

1. Field of the Invention

This invention relates to systems and methods for enhancing mobile devices and/or devices with touch-sensitive display screens.

2. Description of Related Art

Phones such as the Apple iPhone (Apple Inc. of Cupertino, Calif.) use a multi-touch system for user interface functionality. Multi-touch refers to the device having a touch screen that can sense two or more simultaneous contact inputs. Gestures such as dragging and pinching two fingers together, or widening two fingers apart when dragging on the screen are used to control program functionality. In most devices, however, the touch screen can only sense one contact input at a time. This is inconvenient for programs desirous of the ability to utilize a multi-touch input without a touch screen capable of receiving multiple touch inputs. Multi-touch screens can also be inconvenient for users with only one hand to use on the device (i.e., needing to hold the device and to drag multiple fingers on the face of the device concurrently with a single hand), for example while driving or for disabled users with a single hand or missing digits.

Therefore, a need exists for emulation software for allowing multi-touch behavior using a touch screen capable of supporting only a single contact input.

Certain operating systems, such as those operating on mobile devices, for example WindowsCE (Microsoft, Inc. or Redmond, Wash.), place a limit on the amount of heap memory available to each process. However, there is also a shared memory space for memory that is unassigned, but that a process could use in addition to its own private memory if assigned to the process. For example, on a 64MB device, some operating systems limit the process-designated memory to 32MB, yet there is still additional memory available to the process in the shared memory area.

Therefore, a need exists for software that can allocate shared memory to the private heap memory, regardless of the per process memory limitation by the operating system.

Usually high interactivity is desired on a client device display for functions such as zooming and panning when viewing a web page or other rendered mark-up code. In the past, there was not enough computational power on the client device to allow for smooth and full browser rendering on the client device. As shown in FIG. 6, a common solution to the computation limitations of the client device was to split the rendering functions between the client and server devices. Typically, the server does much rending and sends the page in a simplified format to the client. The client then renders a simplified version of the page using the simplified format description. This allows the client to display the page using less computational power, but often page interactivity is lost.

Alternatively, as shown in FIG. 7, the client device can perform the entire rendering without the server. This eliminates the delay from the server device, but requires the client device to re-render the entire page from the original mark-up if particular manipulations (e.g., scale changes for zooming) are required.

Therefore, there exists a need for a rendering process that can be performed entirely on the client device, yet also preserves partial rendering of the page.

### BRIEF SUMMARY OF THE INVENTION

A system and method for enabling the use of multi-touch applications on a device with a touch screen configured to only receive a single touch input at a time is disclosed. For example, the device can be a computer such as a cellular phone or PDA. The device can perform manipulation of at least the first cursor and a second cursor. For example, this can be performed by a multi-touch software application (i.e., computer code), process, or function.

The device can receive a first touch input on the touch screen. The device can then control the first cursor location for the first cursor based on the first touch input (e.g., if the first touch input is dragged across the screen, the first cursor can similarly move across the screen). The device can then toggle off the first cursor being the active cursor and make the second cursor the active cursor. The device can then receive a second touch input on the touch screen. The device can then control the second cursor location for the second cursor with the second touch input.

The device can then toggle off the second cursor being the active cursor and either toggle back to the first cursor being the active cursor or signal completion of the controlling of the first cursor and the second cursor. If completion of the cursor controls is signaled, the device can deliver the initial, and/or final, and/or change in locations of the first cursor and the second cursor to a multi-touch function (e.g., the operating system, a web browser, a picture or video viewer, an audio player).

The device can have a dual heap software application (i.e., computer code), process or function that can allocate shared and private memory to an executing software application. The dual heap process can allocate memory in a variation selected by the user or by a default (e.g., manufacturer-based) setting, or optimized base on the executing software application, or a combination thereof. The dual heap process can use the same memory allocation scheme for a single executing software application and/or a variety of memory allocations for a single executing software application.

The dual heap process can allocate memory so that the private memory is completely utilized before the shared memory is allocated. The dual heap process can allocate memory so that the memory allocation is alternated between the private and shared memory in about equal portions or for every memory request by the software application. The dual heap process can allocate memory so that small memory needs for the executing software application are allocated from one of the memory heaps (e.g., private or shared) and large memory needs are allocated from the other memory head (e.g., shared or private, respectively).

The device can have a meta-layer software application (i.e., computer code), process or function. The meta-layer process can render mark-up code. For example, the meta-layer process, or an application (e.g., web browser) within which the meta-layer process is functioning can receive a complete mark-up code file. The device (e.g., via the application and/or meta-layer process) can partially render the mark-up code, save the partially-rendered meta-layer mark-up code, and then complete the rendering and output (e.g., via the display and/or speakers) the completely rendered mark-up code. The saved meta-layer mark-up code can be finally rendered later, if needed, for example to alter the scale of the output of the fully rendered mark-up code.

### BRIEF DESCRIPTION OF THE DRAWINGS

FIG. 1a illustrates a variation of a client device having a touch screen. The client device can be a mobile phone or personal data assistant, for example.

FIG. 1b illustrates the device of FIG. 1a with a variation of a method for the client device in multi-touch mode with two cursors shown.

FIG. 1c illustrates the device of FIG. 1a with a variation of a method for moving a first cursor on the screen during multi-touch mode.

FIG. 1d illustrates the device of FIG. 1a with a variation of a method for toggling between cursors in multi-touch mode.

FIGS. 1e and 1f illustrate the device of FIG. 1a with a variation of a method for moving the second cursor during multi-touch mode.

FIG. 1g illustrates the device of FIG. 1a with a variation of a method for releasing multi-touch mode and activating the multi-touch function.

FIG. 2 illustrates a variation of a method for utilizing a multi-touch device.

FIGS. 3a and 3b illustrate a variation of a method for using a dual-heap system.

FIGS. 4a, 4b and 4c illustrate a variation of a method for using a dual-heap system.

FIGS. 5a through 5d illustrate a variation of a method for using a dual-heap system.

FIGS. 6 and 7, not the invention, illustrate variations of methods for rendering mark-up pages utilizing client devices.

FIG. 8 illustrates a variation of a method for rendering mark-up pages utilizing a client device.

### DETAILED DESCRIPTION

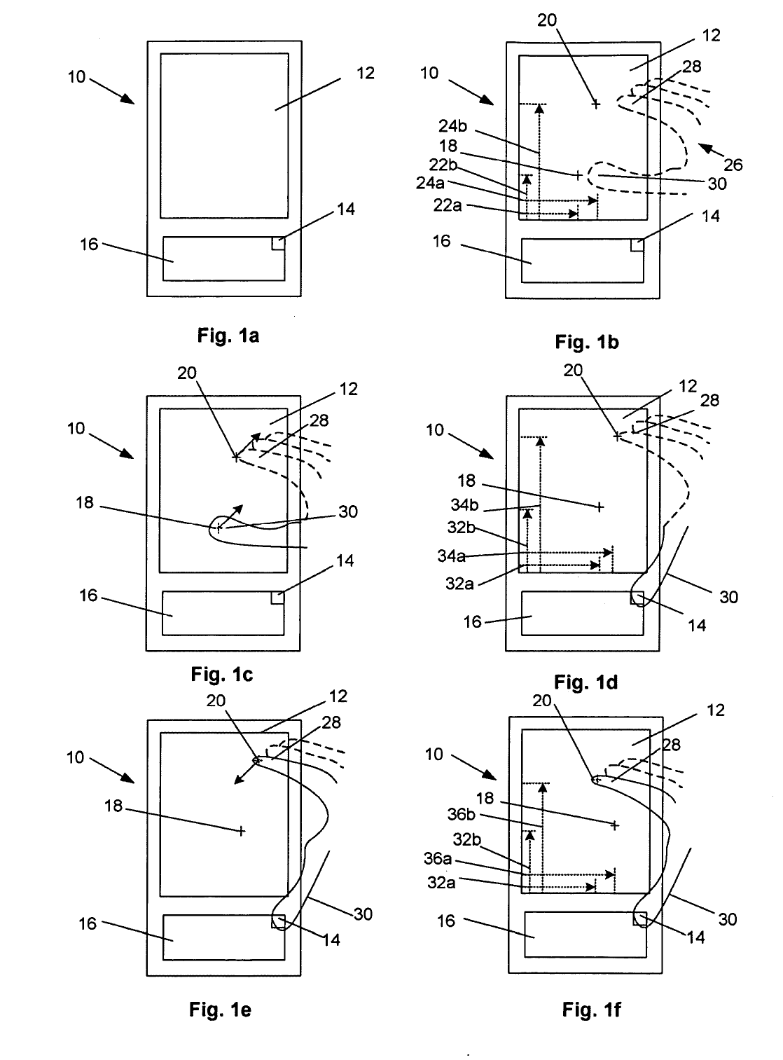

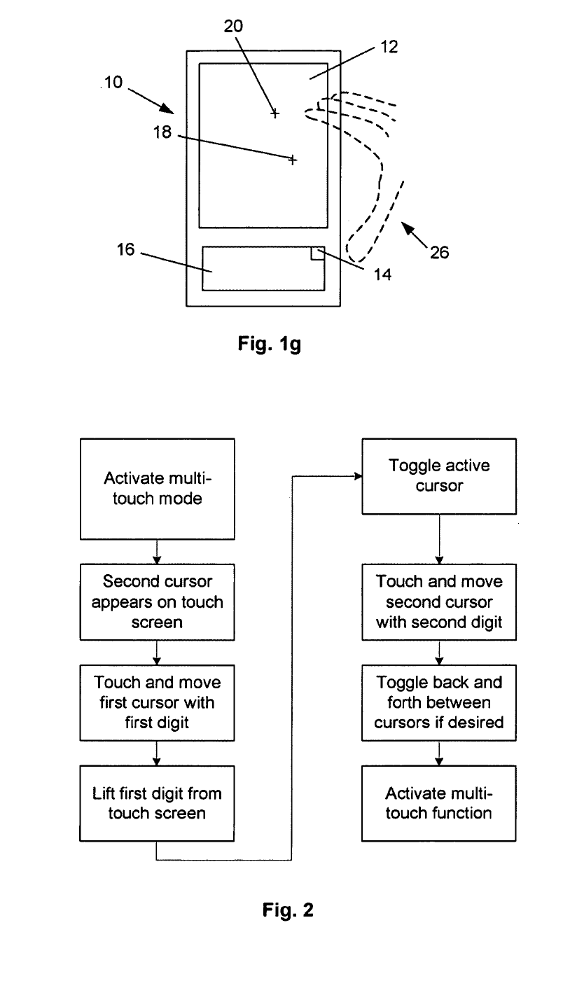

FIG. 1 illustrates a variation of a client device 10. The client device 10 can be a computer, such as a mobile phone (e.g., cellular phone, satellite phone, cordless phone), a personal data assistant, a peripheral input/output device attached to a desktop or laptop computer or a retail device (e.g., an optical scanning “gun” connected to a retail register). The client device 10 can be in continuous or sporadic communication with a server. For example, the client device 10 can be wired or wirelessly connected to a server.

The client device 10 can have a touch screen 12. The touch screen 12 can be configured to receive inputs on the touch screen 12 due to pressure, for example via contact from a stylus or one or more of the user's digits. The touch screen 12 can be configured to receive a single pressure source (e.g., stylus, finger) at a given time.

The client device 10 can have a multi-touch button or key 14. The multi-touch key 14 can be the only non-screen based input device on the client device 10 or the multi-touch key 14 can be one of two or more non-screen based input devices, such as being part of or separate from a keyboard 16. The multi-touch key 14 can be on the front, either side, back, top or bottom of the client device 10. The client device 10 can have more than one multi-touch key 14.

The client device 10 can have a processor and memory and be configured to execute computer software. The client device 10 can be, for example, an HTC 8925 (HTC Corporation of Taoyuan, Taiwan).

The client device 10 can execute a multiple-touch (“multi-touch”) software application that can allow a user to control the location of multiple cursors on the touch screen with a single contact point. For example, the multi-touch software can enable the client device 10 to use a software application requiring multiple contact points (e.g., an application that zooms when two fingers are dragged toward or away from each other). The multi-touch software application can be executed concurrently with other programs. For example, the multi-touch software application can be executed concurrently with a graphics-displaying application, such as a video or image file displaying application and/or a web browser.

FIG. 1b illustrates that the device 10 can be placed into a multi-touch emulation mode (“multi-touch mode”). When the multi-touch mode is activated, for example, a first cursor 18 and a second cursor 20 can be displayed on the touch screen 12. Additional (e.g., third, fourth) cursors can also be displayed on the touch screen 12.

The multi-touch mode can be indicative that the multi-touch software is executing at all, or the multi-touch mode can be activated by the multi-touch software even though the multi-touch software can also be executing in a “sleep” mode when the multi-touch mode is off. The multi-touch mode can be activated by a control, such as the multi-touch key 14, a menu item selected via the keyboard, the touch screen, or audio control (e.g., voice activation) via an audio transducer, such as a microphone, or combinations thereof.

The first cursor 18 can initially be at a first cursor first x-location 22a and a first cursor first y-location 22b on the touch screen 12. The second cursor 20 can be at a second cursor first x-location 24a and a second cursor first y-location 24b. The first cursor first x-location 22a can be equal to, greater than or less than the second cursor first x-location 24a. The first cursor first y-location 22b can be equal to, greater than or less than the second cursor first y-location 24b. For example, the first cursor 18 and the second cursor 20 can be vertically aligned. The first cursor 18 and the second cursor 20 can be vertically or horizontally aligned. The first cursor and second cursor first x and y-locations 22a, 22b, 24a and 24b, can be preset to match user-defined preferences. For example, the user can set the first cursor and second cursor first x and y-locations 22a, 22b, 24a and 24b to fit the user's hand size and/or handedness.

The multi-touch software can have predefined (e.g., by the user and/or by the manufacturer) left and right-handedness settings for the first cursor and second cursor first x and y-locations 22a, 22b, 24a and 24b. For example, the right-handedness can have a smaller first cursor first x-location 22a than the second cursor first x-location 24a setting. The left-handedness setting can have a larger first cursor first x-location 22b than the second cursor second x-location 24b setting. The multi-touch software can have predefined hand size settings (e.g., small, medium and large) for the first cursor and second cursor first x and y-locations 22a, 22b, 24a and 24b. For example, the larger the hand size, the farther away the first cursor 18 is located from the second cursor 20 in the first locations 22a, 22b, 24a and 24b.

Other predefined settings can include whether to initially move the first cursor, the second cursor, or both (or all) cursors concurrently.

The user's hand 26 (digits such as finger 28 and thumb 30 are also shown) can be near the client device 10. The hand 26 is shown in FIG. 1b in phantom lines to indicate it is not in contact with the client device 10.

The multi-touch software can define the first cursor 18 as the initially active cursor. The active cursor can be the cursor to be moved or otherwise controlled by user interaction with the touch screen.

FIG. 1c illustrates that a stylus or digit, such as the thumb 30, can be pressed to the touch screen 12 (indicated by the thumb 30 being in solid lines in FIG. 1c), for example on the first cursor 18. The thumb 30 can then drag across the touch screen 12. The multi-touch software can move, as shown by arrow, the first cursor 18 with the movement of the thumb 30. The multi-touch software can move, as shown by arrow, the second cursor 20 concurrently, for example in identical motion, with the first cursor 18, or the second cursor 18 can remain motionless during the motion of the first cursor 18. Whether the second cursor 18 moves or remains motionless during the motion of the first cursor 20 can be a default setting or manually selected in the user preference settings of the multi-touch software.

FIG. 1d illustrates that after the first cursor 18 is moved, the first cursor 18 can be at a first cursor second x-location 32a and a first cursor second y-location 32b on the touch screen 12. The second cursor 20 can be at a second cursor second x-location 34a and a second cursor second y-location 34b on the touch screen 12. If the multi-touch software is set to not move the second cursor 20 during movement of the first cursor 18, the second cursor second x and y-locations 34a and 34b can be identical to the second cursor first x and y-locations 24a and 24b.

Once the active first cursor 18 has been moved, for example to a desired final location, the active cursor can be toggled by the multi-touch software so the second cursor 20 is the active cursor. Toggling the active cursor from the first cursor 18 to the second cursor 20 can be performed by triggering a control, such as a button on the keyboard or elsewhere, multi-touch key 14, voice command, or menu command selected from the touch screen with the keyboard joystick, other input device, time-out mechanism, or combinations thereof. For example, the thumb 30 can be lifted away from the touch screen 12 and press the multi-touch key 14 to toggle the active cursor. The multi-touch key can be pressed and released to toggle the active cursor, or pressed and held (e.g., releasing the multi-touch key 14 can signal the completion of all cursor movement) to toggle the active cursor. The active cursor can be toggled back and forth one or more times between the first and second cursors 18 and 20, and other cursors if available.

FIG. 1e illustrates that the finger 28 can be pressed (as indicated by the finger 18 being shows in solid lines) to the touch screen 12, for example when the second cursor 20 is the active cursor. The finger 28 can be dragged, as shown by arrow, across the touch screen 12. The multi-touch software can keep the first cursor 18 motionless and move the second cursor 20 corresponding to the movement of the finger 28.

FIG. 1f illustrates that after the second cursor 20 is moved, the second cursor can be at a second cursor third x-location 36a and a second cursor third y-location 36b on the touch screen 12.

After moving the second cursor 20, the active cursor can be toggled back to the first cursor 18 if desired. The method can also be used to toggle between and move additional active cursors, such as third and fourth cursors.

FIG. 1g illustrates that after the first cursor 18 and the second cursor 20 are moved to final desired positions, the user's hand 26 can be removed from the touch screen 12. The multi-touch function can then be activated, for example, by pressing or releasing the multi-touch key 14, voice activation, or combinations thereof. The multi-touch function that is the process or application that receives the location of the cursors as input. The multi-touch function can be, for example, a function within a program for viewing images, video, playing audio files, web browsers, word processing, spreadsheets, animation effects, scientific data viewing/analysis, or combinations thereof. The multi-touch function can be for zooming (e.g., in/out, center, cursor-based zooming, default zoom settings), panning, scrolling, toggling between applications or options within applications, web browser operations (e.g., page forward, page back, refresh page), rotating, stretching, animation and lighting special effects, or combinations thereof

FIG. 2 illustrates a functional flow of the use of the multi-touch software application. For example, the multi-touch mode can be activated. The first and second (and any additional) cursors can then appear on the touch screen if the cursors were not already displayed on the touch screen. The user can then touch and drag the first cursor with a stylus or first digit, such as the thumb. The user can then lift the stylus or first digit off the touch screen. The user can then toggle the active cursor from the first cursor to the second cursor. The toggling can occur by pressing and holding the multi-touch key, and/or pressing and releasing the multi-touch key, or by other methods described herein. The user can now touch the second cursor, now the active cursor, and drag the second cursor to a desired location. The user can touch the second cursor with the stylus or the first or a second digit, such as the forefinger. If desired, the user can toggle the active cursor back to the first cursor and reposition the first cursor, and then toggle to the second cursor and reposition the second cursor, ad infinitum. When the first and second (and other) cursors are in desired locations, the multi-touch key can be released or pressed and held, or other input signal can be given to activate the multi-touch function.

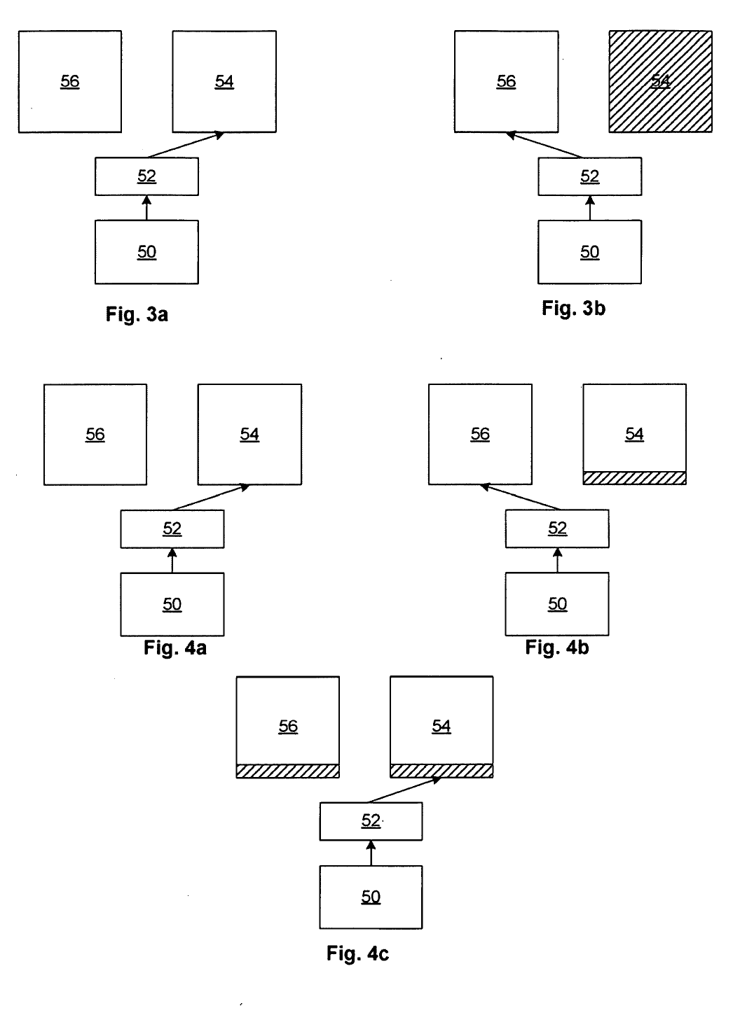

FIG. 3a illustrates that an executing software application 50 on the client device can interact with a dual heap process 52. The executing software application 50 can be a web browser, photo effects program, any other application listed herein, or other applications.

The client device can have private memory 54 and shared memory 56. Shared memory 56 is memory not yet assigned to an executing application. The private memory 54 can be allocated by the operating system to the executing software application. The dual heap process 52 can execute within the operating system of the client device, as a stand-alone application or within the executing software application. The dual heap process 52 can access the shared memory 56 and the private memory 54. The dual heap process 52 can control the location of the memory used by the executing software application 50.

As shown in FIG. 3a, the dual heap process can allocate memory for the executing software application from the private memory. The dual heap process can continue to utilize the private memory for the executing software until the private memory is completely used.

FIG. 3b illustrates that when the private memory is substantially completely used by the executing software application, the dual heap process can begin to allocate the shared memory for the executing application. After the private memory is initially filled, if any private memory is freed from use during the executing of the executing software application, the dual heap process can assign the recently-freed private memory to the executing software application (i.e., to refill the private memory before returning to use additional shared memory).

FIG. 4a illustrates that the dual heap process 52 can initially allocate memory from the private memory 54 to the executing software application 50. The amount of memory initially allocated from the private memory 54 can be a predetermined quantity of memory (e.g., about 200 kBytes).

FIG. 4b illustrates that once the predetermined quantity of memory has been initially allocated from the private memory 54, the dual heap process 52 can allocate memory from the shared memory 56 to the executing software application 50. The amount of memory initially allocated from the shared memory 56 can be a predetermined quantity of memory (e.g., about 2 MB).

FIG. 4c illustrates that once the predetermined quantity of memory has been initially allocated from the shared memory 56, the dual heap process 52 can allocate additional memory from the private memory 54 to the executing software application 50. The amount of memory additionally allocated from the private memory 54 can be a predetermined quantity of memory, for example the same predetermined quantity of memory allocated initially from the private memory 54 and/or shared memory 56 (e.g., about 2 MB).

The dual head process 52 can continue to alternate memory allocation to the executing software application 50 between the private memory 54 and the shared memory 56 in approximately equally sized increments of memory (e.g., about 2 MB) until the private memory 54 or shared memory 56 is filled, at which time the dual heap process 52 can allocate no additional memory to the executing software application 50, or the dual heap process 52 can allocate additional memory to the executing software application 50 from whichever of the private or shared memories 54 or 56 that still have available memory.

The evenly alternating memory allocation method by the dual heap process 52 shown in FIGS. 4a through 4c can begin by allocating memory from the private memory 54 (as shown) or from the shared memory 56.

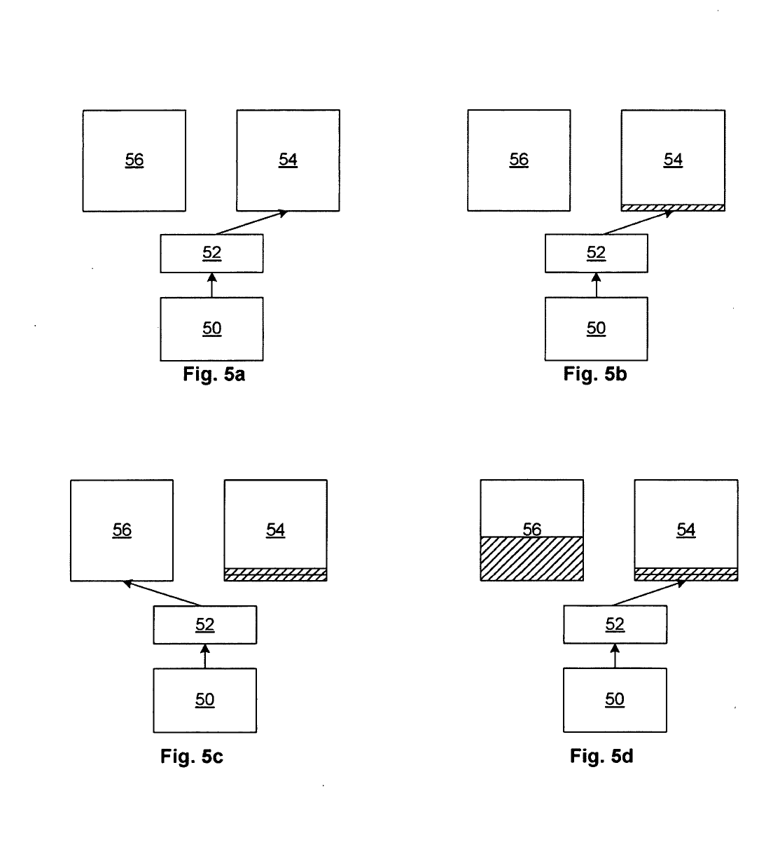

FIGS. 5a through 5d illustrate that the dual heap process 52 can alternate allocation of memory between the private memory 54 and the shared memory 56 based on the size of the individual allocation of memory needed. For example, the dual heap process can allocate larger individual allocations (e.g., greater than about 200 kBytes) of memory from the shared memory 56 and smaller individual allocations (e.g., smaller than about 200 kBytes) of memory from the private memory 54, or vice versa (i.e., smaller allocations from the shared memory 56 and larger allocations from the private memory 54).

FIG. 5a illustrates that the dual heap process 52 can allocate a first small individual memory allocation from the private memory 54 for the executing software application 50.

FIG. 5b illustrates that the dual heap process 52 can then allocate a second small individual memory allocation from the private memory 54 for the executing software application 50.

FIG. 5c illustrates that the dual heap process 52 can then allocate a first large individual memory allocation from the shared memory 56 for the executing software application 50.

FIG. 5d illustrates that the dual heap process 52 can then allocate a third small individual memory allocation from the private memory 54 for the executing software application 50.

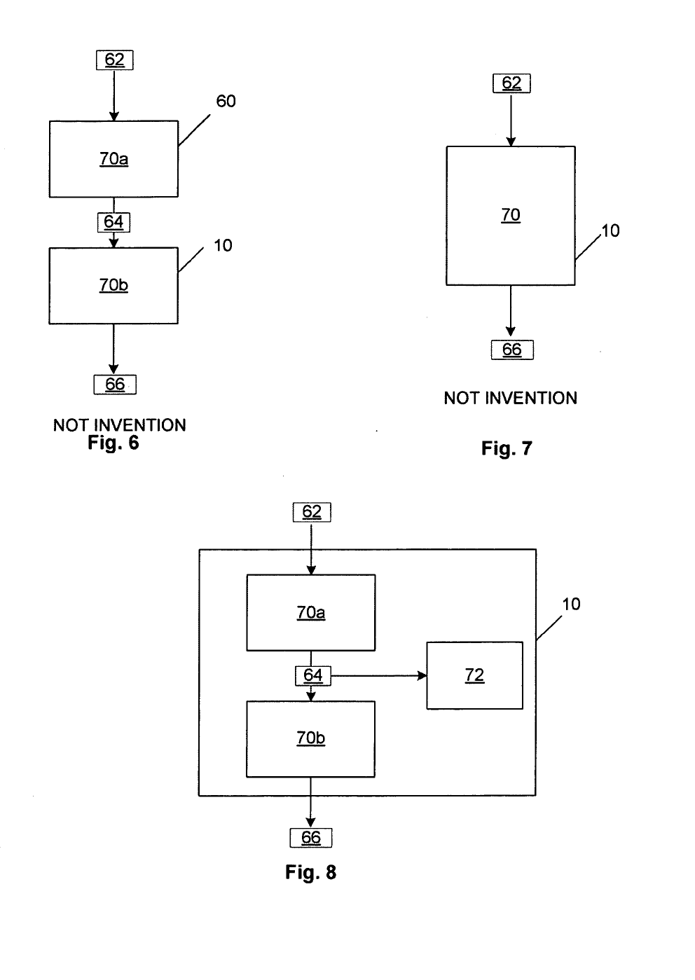

FIGS. 6 and 7 illustrate various known methods of rendering mark-up code. FIG. 6 illustrates that a server device 60 can receive or retrieve the unrendered mark-up code 62, for example hyper-text mark-up for a web page. The unrendered mark-up code 62 is then processed by the server device to partially render 70a the code to meta-mark-up code 64. The meta mark-up code can be a simplified version of the unrendered mark-up code 62, for example that can be processed into completely rendered mark-up code more easily by the client device 10. The meta mark-up code 62 is then sent to the client device 10. The client device 10 can perform final complete rendering 70b on the meta-mark-up code 64. The client device 10 can then output the final completely rendered mark-up 66, for example in the form of graphics, text, video, audio, other output or actions or combinations thereof.

FIG. 7 illustrates that the complete rendering 70 of the mark-up code 62 is performed entirely on the client device 10, resulting in the final completely rendered mark-up 66.

FIG. 8 illustrates that the client device 10 (e.g., via a web browser) can receive or retrieve the unrendered mark-up 62. The unrendered mark-up code 62 can then be partially rendered 70a into a meta mark-up code 64 (i.e., a meta layer) within the client device 10. For example, a meta-layer client process or application can partially render and/or save 72 the partially rendered meta mark-up code 64. The meta-layer client process can be executed within the operating system, as a stand-alone application, within the mark-up rendering application (e.g., a web browser), or a combination thereof.

The meta mark-up code 64 can then be finally and completely rendered 70b into the final completely rendered mark-up 66 by the client device 10.

If the final rendering 70b is desired to be re-performed (e.g., to rescale a web page for zooming, panning, or to render for pull down menus or other click-activated actions), the client device 10 can retrieve the saved meta mark-up code 64 from memory on board the client device 10. The client device 10 can then re-perform the final complete rendering on the meta mark-up code 64 with the new criteria (e.g., rescale ratio), for example, without the need to retrieve or receive the unrendered mark-up 62 nor the need to partially render the unrendered mark-up to the meta mark-up 64 configuration. Therefore, the meta-layer client process can reduce the processing resources and time required by the client device 10, and reduce repeated downloading of unrendered of partially rendered mark-up 62 or 64 from the server device 60 to the client device 10.

The first meta mark-up code 64 can be saved on the client device 10 while the client device retrieves and processes a second, third, or more mark-up codes 62. Also, first, second, third, or more meta mark-up codes 64 can also be concurrently saved 72 on the client device 10, and retrieved as desired.

The mark-up code can be HTML, XML, SVG, SMIL, XHTML, or combinations thereof.

The multi-touch software application, the dual heap process and the meta-layer client process can be used concurrently and/or sequentially with each other on a single client device, for example with and/or in a single web browser application.

As used herein, software applications are a set of instructions that can be executed by one or more processors in the client device 10. The software applications can be executed within the operating system of the client device 10 or as a process separate from the operating system.

It is apparent to one skilled in the art that various changes and modifications can be made to this disclosure, and equivalents employed, without departing from the spirit and scope of the invention. Elements shown with any variation are exemplary for the specific variation and can be in used on or in combination with other variations within this disclosure.

We claim:

1. A computer implemented method of performing manipulation of at least a first cursor and a second cursor using a device comprising a touch screen configured to detect a single contact point at a single time, the method comprising:
receiving a first touch input on the touch screen;
controlling a first cursor location for the first cursor with the first touch input;
toggling off the first cursor;
receiving a second touch input on the touch screen; and
controlling a second cursor location for the second cursor with the second touch input.

2. The method of claim 1, further comprising executing a function with the first cursor location and the second cursor location.

3. The method of claim 1, further comprising toggling off the second cursor after the controlling of the second cursor location; receiving a third touch input on the touch screen; and controlling the first cursor location for the first cursor with a third touch input.

4. The method of claim 1, further comprising toggling off the second cursor wherein the toggling off the second cursor comprises signaling completion of the controlling of the first cursor and the second cursor.

5. The method of claim 1, further comprising delivering the first cursor location and the second cursor location to a multi-touch function.

6. The method of claim 1, wherein toggling comprises receiving an input from a key being pressed by a user.

7. The method of claim 1, wherein toggling comprises receiving an input from a microphone.

8. The method of claim 1, further comprising executing a dual heap process on the client device.

9. The method of claim 1, further comprising executing a meta-layer process on the client device.

10. A computer program product that performs a method for manipulation of at least a first cursor and a second cursor on a client device comprising a touch screen configured to detect a single contact point at a single time, comprising:
computer code that receives a first touch input on the touch screen;
computer code that controls a first cursor location for the first cursor with the first touch input;
computer code that toggles off the first cursor;
computer code that receives a second touch input on the touch screen; and
computer code that controls a second cursor location for the second cursor with the second touch input.

11. The computer program product of claim 10, further comprising computer code that executes a function with the first cursor location and the second cursor location.

12. The computer program product of claim 10, further comprising computer code that toggles off the second cursor after the controlling of the second cursor location; receiving a third touch input on the touch screen; and controlling the first cursor location for the first cursor with a third touch input.

13. The computer program product of claim 10, further comprising computer code that toggles off the second cursor wherein the toggling off the second cursor comprises signaling completion of the controlling of the first cursor and the second cursor.

14. The computer program product of claim 10, wherein the toggling comprises receiving an input from a key being pressed by a user.

15. The computer program product of claim 10, wherein the toggling comprises receiving an input from a microphone.

16. The computer program product of claim 10, further comprising computer code that executes a dual heap process on the client device.

17. The computer program product of claim 10, further comprising computer code that executes a meta-layer process on the client device.

18. A portable computer device comprising:
a processor;
a touch screen configured to detect a single contact point at a time; and
a control configured to activate a multi-touch mode for the device.

19. The device of claim 16, wherein the control comprises a button.

20. The device of claim 16, wherein the control comprises an audio transducer.
